(19) United States
(12) Patent Application Publication
(10) Pub. No.: US 2026/0217524 A1
(43) Pub. Date: Jul. 30, 2026

(54) SYSTEMS AND METHODS FOR GENERATING HYDROGEN FROM IRON ORE TAILINGS

(71) Applicants: Alliance for Energy Innovation, LLC, Golden, CO (US); USA Fortescue IP, Inc., Wilmington, DE (US)

(72) Inventors: Xiaofei PU, Arvada, CO (US); Savannah Lynn RICE, Denver, CO (US)

(21) Appl. No.: 19/363,266

(22) Filed: Oct. 20, 2025

Related U.S. Application Data
(63) Continuation of application No. PCT/US25/51645, filed on Oct. 20, 2025.
(60) Provisional application No. 63/712,256, filed on Oct. 25, 2024.

(51) Int. Cl. C01B 3/061; B01D 53/26; C01B 3/506

(52) U.S. Cl. CPC C01B 3/061; B01D 53/265; C01B 3/506; B01D 2256/16; B01D 2257/80; C01B 2203/046; C01B 2203/1205

(57) ABSTRACT

Among other things, a process for generating hydrogen by valorizing iron ore tailings (IOT) through the oxidation of remnant ferrous iron phases in the tailings is described. The IOT may be either wet (i.e., containing water) or dry (i.e., not containing water). The reaction may be performed using untreated IOT and may generate hydrogen gas capable of being used on site.

### CROSS-REFERENCE TO RELATED APPLICATIONS

This application is a continuation of PCT/US25/51645 filed on Oct. 20, 2025, which claims priority to U.S. Provisional Patent Application No. 63/712,256 filed on Oct. 25, 2024, each of which is hereby incorporated by reference in its entirety.

### CONTRACTUAL ORIGIN

This invention was made with government support under Contract No. DE-AC36-08GO28308 awarded by the Department of Energy. The government has certain rights in this invention.

### BACKGROUND

Hydrogen can be generated through several different commercial methods. The most common ones today are steam methane reforming and electrolysis. In recent years, there has been increased interest in naturally-generated hydrogen from subsurface geologic systems, referred to as geologic hydrogen. Thus, there remains a need to collect and utilize geologic hydrogen.

### SUMMARY

An aspect of the present disclosure is method of generating a hydrogen gas product from an iron ore tailing (IOT), the method including feeding the IOT into a reactor, mixing the IOT in a reactor resulting in the hydrogen gas product and a slurry waste, and collecting the hydrogen gas product from the reactor. In some embodiments, the method also includes combining the IOT with a liquid, in which the combining is performed prior to the mixing, and the liquid comprises water. In some embodiments, the IOT includes at least 1 wt % water. In some embodiments, the method also includes grinding the IOT, in which the grinding is performed before the feeding, and the grinding results in the IOT having a grain size. In some embodiments, the grain size is less than approximately 50 microns. In some embodiments, the grain size is less than approximately 20 microns. In some embodiments, the method also includes purifying the hydrogen gas product, in which the purifying occurs after the collecting. In some embodiments, the purifying includes cooling the hydrogen gas product, and the cooling results in a water being condensed out of the hydrogen gas product. In some embodiments, the purifying includes separating the hydrogen gas product, and the separating includes removing another gas from the hydrogen gas product. In some embodiments, the another gas includes at least one of methane, carbon dioxide, nitrogen, or oxygen. In some embodiments, the method also includes disposing of the slurry waste, in which the disposing occurs after the collecting. In some embodiments, the mixing includes stirring the IOT and heating the IOT. In some embodiments, the heating results in the mixture being at a temperature less than 150° C. In some embodiments, the mixing is performed for a time in the range of approximately 24 hours to 6 months. In some embodiments, the reactor includes an interior space, a heating mechanism, a stirring mechanism located in the interior space, an inlet, a first outlet, and a second outlet. In some embodiments, the heating mechanism includes an electric heater or a hydrogen burner. In some embodiments, the hydrogen burner utilizes the hydrogen gas product. In some embodiments, the heating mechanism is capable of heating the interior space to approximately 500° C. In some embodiments, the stirring mechanism comprises an agitator, and the agitator is configured to move to mix the IOT and the liquid. In some embodiments, the collecting includes removing the slurry waste from the reactor via the first outlet and removing the hydrogen gas product from the reactor via the second outlet.

### BRIEF DESCRIPTION OF THE DRAWINGS

Some embodiments of the present disclosure are illustrated in the referenced figures of the drawings. It is intended that the embodiments and figures disclosed herein are to be considered illustrative rather than limiting.

FIG. 1 illustrates a process flow diagram for a process of generating a hydrogen gas product from iron ore tailings (IOT), according to some aspects of the present disclosure.

FIG. 2 illustrates a reactor and the process for generating a useable hydrogen product from IOT, according to some aspects of the present disclosure.

FIG. 3 illustrates an exemplary process flow diagram for a process generating a hydrogen gas product from IOT, according to some aspects of the present disclosure.

FIG. 4 illustrates exemplary steps in a method for generating hydrogen gas from IOT, according to some aspects of the present disclosure.

REFERENCE NUMERALS

| | |
|---|---|
| 100 | device |
| 105 | reactor |
| 110 | IOT |
| 115 | water |
| 120 | heating element |
| 125 | doors |
| 130 | inlet |
| 135 | outlet |
| 140 | hydrogen gas product |
| 145 | spent IOT |
| 150 | crusher |
| 155 | conveyor belt |
| 160 | water filtration |
| 165 | water treatment |
| 200 | method |
| 205 | grinding |
| 210 | feeding |
| 215 | combining |
| 220 | mixing |
| 225 | collecting |
| 230 | purifying |
| 235 | disposing |

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

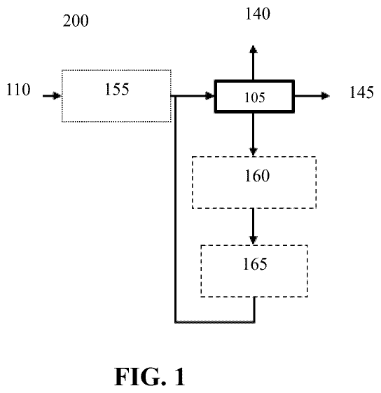

Among other things, the present disclosure relates to a process for generating hydrogen by valorizing iron ore tailings (IOT) through the oxidation of remnant ferrous iron phases in the tailings. The IOT may be either wet (i.e., containing water) or dry (i.e., not containing water). A process flow diagram of the method 200 is outlined in FIG. 1.

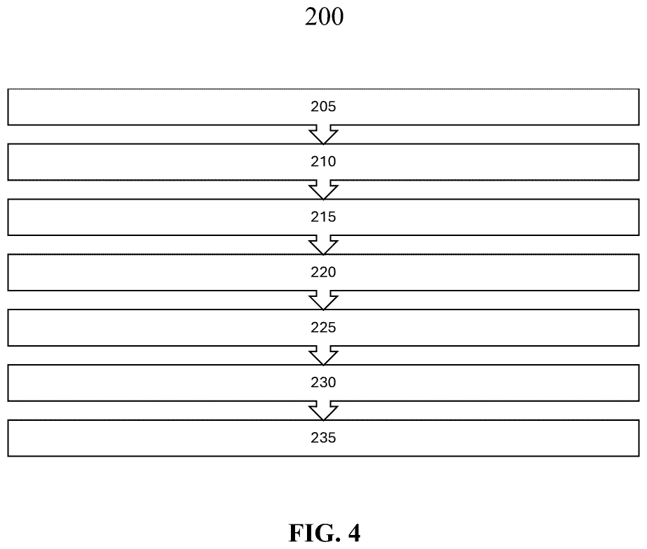

FIG. 1 illustrates a simple process flow diagram of the method 200 of generating a hydrogen gas product 140 from IOT 110. The IOT is fed 210 (see FIG. 4) into a reactor 105 using a conveyor belt system 155. In the reactor 105 the IOT 110 reacts with either water 115 (not shown in FIG. 1) in the IOT or added water to generate the hydrogen gas product 140. From the reactor 105 the hydrogen gas product 140, spent IOT 145, and excess water 160 emerge via separate outlets (135a and 135b). In some embodiments the excess water 160 may be treated and reused in the method 200.

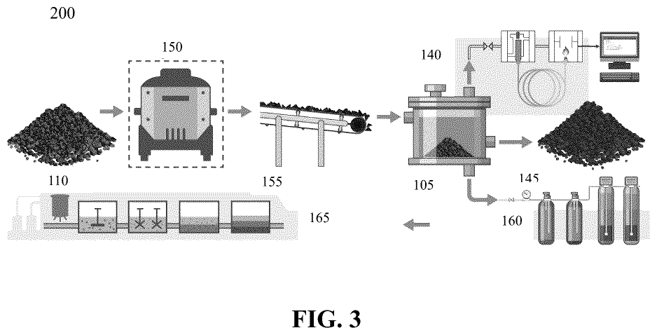

In some embodiments, the present disclosure may produce clean hydrogen (H₂) from the redox reactions between IOT 110 and water 115 in an industrial facility at an iron mining site (See FIG. 3), where abundant IOT 110 supplies and H₂ end-use opportunities are present. IOT 110 mineralogy varies but notably contains ferrous iron (Fe²⁺)-bearing minerals, such as magnetite. The chemical reaction for magnetite is

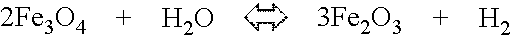

where ferrous iron is oxidized to ferric iron and water is reduced to hydrogen. Upon complete oxidization of the Fe²⁺-bearing minerals in IOT 110, preliminary calculation indicates approximately 2 million tons (Mt) of H₂ can be produced as low as $0.91/kg from the annual 1.4 billion tons (Gt) of IOT 110 that are generated globally, making this a new promising breakthrough technology to produce hydrogen for on-site use.

As used herein, IOTs 110 may be waste materials generated from iron mining that are excavated and processed along with the iron ore before being separated from ore grade materials. With some variations, IOT 110 are generated at a volume in the range of about 1 to about 4 times the amount of iron ore that is produced at any given mine. During the method 200 of the present disclosure (See FIG. 4), the IOT 110 may be crushed or ground 205 further to enhance the reaction rate, before being sent along a conveyer belt 155 into a pressurized and heated reactor 105 vessel to react with water 115 at higher temperature and pressure conditions. The water 115 may be either present in the IOT 110 or combined 215 with the IOT 110 in the reactor 105. The hydrogen gas product 140 may be collected 225, and the spent IOT 145 may be removed (i.e., disposed 235) and sent to beneficiation once the reaction is deemed complete. The residual water 160 and the residual heat produced by the reaction may be treated and reused as is practical.

The chemical reaction at the heart of the method 200 of the present disclosure is somewhat similar to geochemical reactions to geologic hydrogen (GeoH₂) production, where Fe²⁺-bearing minerals (mostly olivine and pyroxene) react with water to produce H₂ and Fe³⁺-bearing minerals in Earth's subterranean environment. The chemical reaction is

(Mg,Fe)₂SiO₄+SiO₂+H₂O→Mg₃Si₂O₅(OH)₄+Fe₃O₄+H₂ (not mass balanced)
where olivine reacts with water to produce serpentine, magnetite and hydrogen.

Compared to the source rocks for GeoH₂, IOT 110 is generally 1) a low-value waste material that is already above the surface; 2) at a finer grain size (average of about 40 μm) than the subsurface source rocks for GeoH₂ (which are about cm to about meter sized); 3) with potentially higher Fe contents than the source rocks for GeoH₂ production, and 4) capable of being processed to produce and use the hydrogen on site without long-distance transportation on each end.

A benefit of the methods 200 described herein is that IOT 110 is a substantially no-cost waste material, has already been excavated to the surface and can be placed into a controlled facility for hydrogen production reactions. This avoids the high cost of drilling, subsurface engineering, and reservoir management that is required for GeoH₂ production. The proposed system for producing hydrogen described herein also does not require critical minerals.

In some embodiments, IOT 110 has already been ground 205 to in the range of about 10-40 μm grain size prior to being used to generate hydrogen, which may significantly accelerate the reaction rate compared to the natural rocks in Earth's subsurface. In some embodiments, the IOT 110 may need to be ground 205 to a desired size prior to feeding 210 the IOT 110 into the reactor 105.

In some embodiments, the method 200 of the present disclosure uses onsite waste materials (i.e., IOT 110) for hydrogen production in a facility that can be built nearby, to generate H₂ to replace a fraction of the fossil-fuel-driven process onsite, without the need to transport electrolyzers, feedstocks, and/or H₂ to and from the mine sites which tend to be in remote locations. This improves the overall energy efficiency in this hydrogen production process.

In some instances, IOT 110 consists of minerals that can produce more hydrogen per kilogram of minerals than those in the source rocks for GeoH₂, upon full reaction, as shown in Table 1. Preliminary estimates indicate the methods described herein can produce approximately 0.0014 kg of H₂ per kg of IOT 110, an increase of about 50% from traditional GeoH₂.

When considering fully completed reactions, the maximum H₂ production rates for IOT 110 minerals may be higher than those for GeoH₂ minerals. In other words, to produce about 1 kg H₂, it requires less kilograms of IOT 110 minerals than GeoH₂ minerals, by mass.

FIGS. 3 and 4 illustrate exemplary methods 200 of the present disclosure. In some embodiments, the method 200 may first include grinding 205 the IOT 110 to a desired size. If the IOT 110 is already of a sufficient size (i.e., in the range of approximately 30 μm to approximately 40 μm) the grinding 205 may not be needed. The grinding 205 may be done using a crusher 150.

In some embodiments, the method 200 includes feeding 210 the IOT 110 into a reactor 105. In some embodiments, the feeding 210 may be done using a conveyor belt 155. In some embodiments, water 115 is also fed 210 into the reactor 105 and combined 215 with the IOT 110. The water 115 may either be present in the IOT 110 (i.e., the IOT 110 may be wet) and/or the water 115 may be combined 215 with the IOT.

In some embodiments, the method 200 next includes mixing 220 the IOT 110 and water 115 in the reactor 105. The mixing 220 may be done using a stirring element (not shown in FIG. 3).

Next, the method 200 may include collecting 225 the hydrogen gas product 140. In some embodiments, after collecting 225, the hydrogen gas product 140 may be purified 230 to remove unwanted gases (i.e., carbon dioxide, nitrogen, etc.). In some embodiments, the excess water 160 from the process may be collected 225 and purified 230 to be used in the method 200 again (or for other purposes).

In some embodiments, the spent IOT 145 may be disposed 235 or removed from the site. This may be done in accordance with standard environmental cleanup practices.

TABLE 1
Comparison of mineral chemistry and H₂ production potential (upon full reaction) for
common minerals in IOT and in GeoH₂ source rocks. IOT minerals have higher potential.

| | | | | | Grams of |
|---|---|---|---|---|---|
| | | | | | mineral |
| | | | | | required to |
| | | | | | produce 1 |
| | | | | Fe²⁺ | gram of H₂ |
| | | Mineral | | wt % in | upon full |
| | Mineral | Group | Chemical formula | mineral | reaction |
| Common Fe²⁺ | Olivine (Fo80) | Olivine | (Mg_{0.8}Fe_{0.2})₂SiO₄ | 14.6% | 380.6 |
| bearing minerals | Orthopyroxene (En80) | Pyroxene | (Mg_{0.8}Fe_{0.2})₂SiO₃ | 12.6% | 439.6 |
| in mafic and | Clinopyroxene (Di80) | Pyroxene | Ca(Mg_{0.8}Fe_{0.2})₂Si₂O₆ | 6.8% | 814.6 |
| ultramafic rocks | Arfvedsonite | Amphibole | Na₃Fe²⁺₄Fe³⁺Si₈O₂₂(OH)₂ | 23.3% | 238.0 |
| (geoH2) | Chromite | Spinel | FeCr₂O₄ | 24.9% | 222.3 |
| Common Fe²⁺ | Magnetite | Spinel | Fe₃O₄ | 24.1% | 229.9 |
| bearing minerals | Siderite | Calcite | FeCO₃ | 48.2% | 115.0 |
| in IOTs from | Ankerite | Calcite | Ca(Fe²⁺_{0.6}Mg_{0.3}Mn_{0.1})(CO₃)₂ | 21.1% | 263.3 |
| Pilbara Australia | Stilpnomalene | Smectite | KFe²⁺_{6.3}Mg_{1.6}Fe³⁺_{0.1}Si_{0.5}Al_{11.5}O₂₆(OH)2(H₂O) | 29.6% | 187.6 |
| and the Medabi | Minnesotaite | Talc | (Fe²⁺, Mg)₃Si₄O₁₀(OH)₂ | 21.3% | 259.9 |
| Iron Range in | Greenalite | Serpentine | Fe²⁺_{2.4}Fe³⁺0.4Si₂O₅(OH)₄ | 37.2% | 149.2 |
| Minnesota USA | Pyrite | Sulfide | FeS₂ | 46.6% | 119.1 |

Note:
because the Mg—Fe²⁺ solid solution occurs in most natural minerals, the Fe²⁺ content here is based on an assumption of the Mg/Fe²⁺ ratio. The Fe²⁺ content in the naturally occurring minerals could vary up to about 10% to about 20%.

Previous literature studies on both natural GeoH₂ systems and controlled laboratory experiments indicate H₂ generation from the Fe-redox reaction is predominantly controlled by kinetics, rather than the availability of Fe²⁺-minerals. While there are many studies on the reaction rate of olivine as the source Fe²⁺-minerals for H₂ production, there have not been studies or work on H₂ production rate for IOT 110 minerals in the IOT 110 mineral assemblage.

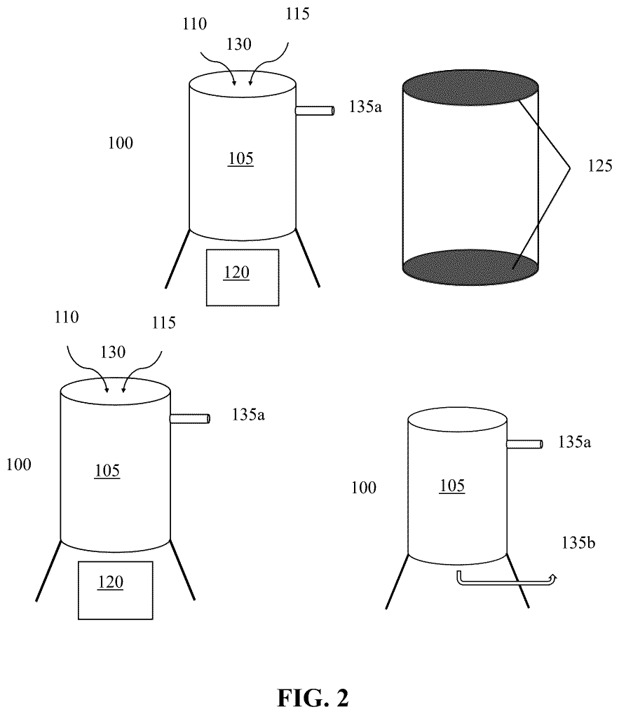

FIG. 2 illustrates a reaction device 100 of the present disclosure. The reactor 105 may include an inlet 130 where the IOT 110 and water 115 (if not sufficiently present in the IOT 110 itself) may be fed 210. The reactor 105 may be connected to a heating element 120, which may be capable of heating the IOT 110 and water 115 to approximately 150° C. The reactor 105 may also include an outlet 135a for removing the hydrogen gas product 140 (not shown in FIG. 2). The outlet 135a for removing the hydrogen gas product 140 may be near the top of the reactor 105. The reactor 105 may also include an outlet 135b for removing the spent IOT 145 and/or excess water 160 resulting from the reaction. Ins some embodiments, the reactor 105 may have the inlet 130 and/or outlets 135 in the form of doors 125.

The serpentinization reaction includes the oxidation and hydration of ferromagnesian minerals, such as olivine or pyroxene in mafic rocks that produces serpentinite and hydrogen, a reaction written as (Mg,Fe)₂ SiO₄+H₂ O→Mg₃Si₂ O₅ (OH)₄+Fe₃O₄+H₂ for olivine, but would be different for other ferromagnesian minerals This process is known to generate hydrogen in varying amounts based on the mineralogy and grain size of the host rock.

The primary mafic mineral included in these reactions is olivine. There are ongoing studies into the reactivity of olivine with water to generate hydrogen. Olivine-rich deposits are regarded as the most promising source for stimulated hydrogen production. A recent experimental study showed that magnetite, an iron oxide mineral, can generate H₂ at a rate 4 to 10 times higher than olivine, which is the most productive GeoH₂ source mineral established in the experimental literature. In some embodiments, the reactions described herein may be performed at lower temperatures (i.e., temperatures under approximately 150° C.). Some embodiments may include generating hydrogen at approximately 90° C. Other embodiments may include performing the reactions described herein at higher temperatures (i.e., temperatures greater than approximately 150° C.).

Several billion tons of iron ore are mined globally every year. Magnetite is a common iron ore mineral which is mined at many locations across the world. Iron ore mining is not entirely efficient at extracting all the iron and iron-rich minerals from ore. IOT 110 are the materials left over after the separation process between the valuable fraction and the uneconomic fraction of an ore, and around 1-1.5 billion tons of IOT 110 are produced per year. On average, between 5 and 20% of the chemical composition of the IOT 110 is iron. This means that millions of tons of iron are left behind in tailings each year globally. Depending on the processing technology used and economic conditions, varying amounts of magnetite may be left behind, between 0.5 and 4%, in the IOT 110.

Anywhere between 10 and 20% of ferrous and ferric iron may also remain in the IOT 110 in various mineral phases, such as stilpnomelane (Fe-mica), other Fe-bearing clay minerals and Fe carbonates. For a large-scale magnetite mine that would produce around 60 million tons of IOT 110 per year when running at full capacity, a significant amount of iron may end up in the IOT based on the volume of the IOT 110 alone.

The IOT 110 may be generated throughout the process of beneficiating magnetite ore. Magnetite is processed through a complex process which can be summarized in these steps: multiple phases of crushing (i.e., grinding 205) to liberate the magnetite from other minerals, dry magnetic separation at a grain size of approximately 4.2 mm, air classification of minerals, wet processing in many incremental sizing and magnetic separation stages as the grain size becomes finer and finer, ultimately producing a concentrate with a P80 particle size of approximately 30 microns and a tailing with a P80 particle size of approximately 44 microns. In some embodiments, the IOT 110 may be ground 205 down (i.e., particle size reduced).

IOT 110 may vary in grain size depending on the exact processing steps used and desired concentrate ore product. The particle size of the IOT 110 may range in size from approximately 30 microns to over approximately 100 microns with a P80 of approximately 44 microns. These IOT 110 may have a variable geochemical and mineralogical composition. The average mineralogical content of the tailings may be in the range of approximately 3% to approximately 5% hematite/magnetite, approximately 11% to approximately 13% iron carbonates, approximately 55% to approximately 57% quartz, approximately 3% to approximately 5% stilpnomelane, and/or approximately 4% to approximately 6% other micas, and minor fractions of many other minerals. The average remaining Fe₃O₄ content of the tailings may be in the range of approximately 0.5% to approximately 4%. The average remaining overall Fe content of the tailings may be in the range of approximately 15% to approximately 20%. The IOT 110 may include at least 1 wt % water (i.e., be wet) or may not include water (i.e., be dry).

The method 200 may include feeding 210 the IOT 110 into a reactor 105, mixing 220 the IOT 110 in a reactor 105 resulting in the hydrogen gas product 140 and slurry waste (i.e., a combination of spent IOT 145 and excess water 160), and collecting 225 the hydrogen gas product 140 from the reactor 105. Some embodiments may include grinding 205 the IOT 110 prior to feeding 210 it into the reactor 105. If the IOT 110 is dry the method 200 may include combining 215 the IOT 110 with water 115 prior to mixing 220. The collecting 225 may involve separating the hydrogen gas from other gases (i.e., steam, methane, etc.). The separating may include cooling the hydrogen gas product 140 to condense steam out of the hydrogen gas product and/or purifying the hydrogen gas product 140 using a separator to remove methane or other gases.

The first step of the process may be transportation of the IOT 110 to the process site and then the IOT 110 may be fed into a crusher 150 for grinding 205. The desired grain size for this reaction may be closer to approximately 10 microns, so crushing the IOT 110 further would provide more reactive surfaces and increase the kinetics of the reaction.

Next, the IOT 110 may be characterized as “wet” (i.e., containing at least approximately 1 wt % water 115) or “dry” (i.e., containing less than approximately 1 wt % water 115). Dry IOT 110 may be mixed with water 115 in a sealed reactor 105 vessel. Depending on the amount of water 115 in the IOT 110, water 115 may be combined 215 with the IOT 110 even if it is “wet.” This water 115 volume used may be in the range of approximately 1 to approximately 100 times the amount of IOT 110. The water 115 may be natural brine or other saline water or may be substantially purified and adjusted to a desired pH, based on the contents of the IOT 110. In some embodiments, the water 115 may be excess water 160 from a prior reaction. In some embodiments, the water 115 may be in the form of steam, depending on the pressure and temperature conditions required for the reaction. The wet IOT 110 may be fed into a sealed reactor 105 vessel, and the water 115 for the reaction may come from the water 115 present in the wet IOT 110 itself.

For either wet or dry IOT 110, this sealed reactor 105 may be fed 210 by a conveyer belt 155 which may feed IOT 110 into the reactor 105 from the top, contains the IOT 110/water 115 mixture within, and has an adjustable and fully sealable door 125 on the bottom with a filtration system to separate the remaining slurry waste material from the excess water 160 when the reaction has concluded. This reactor 105 may also contain a stirring mechanism to agitate (i.e., mix 220) the IOT 110/water 115 mixture periodically to ensure optimal reaction kinetics. An heating element 120 may be used to heat the reactor 105and induce this oxidation reaction. The heating element 120 may be an electric heating element and/or a hydrogen burner. In some embodiments, the resulting hydrogen from the method 200 may be used in the hydrogen burner for the heating. The reactor may be heated in the range of approximately 40° C. to approximately 500° C. The reactor 105 may be pressurized to between approximately 1 bar and approximately 100 bar. This process may run for a duration of approximately one day (i.e., approximately 24 hours) to approximately 6 months (i.e., approximately 180 days) depending on the amount of IOT 110 and water 115 used and/or present in the IOT 110. As a hydrogen gas product 140 is generated from this process, an outtake tube on the reactor 105 may feed the hydrogen gas product 140 into a gas analyzer to determine the gas composition as well as a gas drying apparatus to dehydrate the gas. The products of this process may be a mixed hydrogen gas product 140 and a slurry waste (i.e., a combination of spent IOT 145 and excess water 160). The slurry waste may be emptied from the bottom of the reactor 105 and sent to waste disposal 235 or for beneficial reuse. The hydrogen gas product 140, once fed through the outtake 135 and dryer, may be fed through a hydrogen gas separator unit to achieve substantially high purity hydrogen to be used for fuel cells, or may remain a mixed gas to be used on site a number of industrial purposes. First, this hydrogen gas product 140 could be used for powering hydrogen-powered mining, personal transportation, or supply vehicles. This may eliminate the need to transport hydrogen fuel or electrolyzers from other locations to the remote site, through electrolysis. The hydrogen gas product 140 may be used for hydrogen fueled iron reduction mechanisms known as hydrogen DRI, to create green iron on site and may significantly reduce and/or eliminate the need to generate green hydrogen through electrolysis, transport hydrogen from other locations, and/or assist in creating green iron which may be volumetrically smaller and thus cheaper to ship than iron ore. Depending on specific project and location economics, the hydrogen gas product 140 could be sold to local customers as well. The hydrogen gas product 140 could be used as a feedstock for fuels like green ammonia, sustainable aviation fuel, etc. The hydrogen gas product 140 could be used for heating, replacing natural gas in the winter for heating buildings or for cooking at mine sites.

Currently, most IOT 110 are dried, which requires large amount of thermal/electrical energy. Some of the water 115 absorbed to the IOT 110 could be retailed to facilitate this reaction, and some of the produced water 160 that was separated from the IOT 110 through mechanical processes may be chemically characterized and added back to the hydrogen production reaction, which may reduce the need for fresh water 115 in this hydrogen generation process 200, and also may reduce the demand for drying and waste water treatment for the IOT 110. In some embodiments, the IOT 110 need not be dried or otherwise treated prior to being used in the process for generating a hydrogen gas product 140.

### Examples

Example 1. A method of generating a hydrogen gas product from an iron ore tailing (IOT), the method comprising:
feeding the IOT into a reactor;
mixing the IOT in a reactor resulting in the hydrogen gas product and a slurry waste; and
collecting the hydrogen gas product from the reactor.

Example 2. The method of Example 1, further comprising:
combining the IOT with a liquid; wherein:
the combining is performed prior to the mixing, and
the liquid comprises water.

Example 3. The method of Example 1, wherein:
the IOT comprises at least 1 wt % water.

Example 4. The method of Example 1, further comprising:
grinding the IOT; wherein:
the grinding is performed before the feeding, and
the grinding results in the IOT having a grain size.

Example 5. The method of Example 4, wherein:
the grain size is less than approximately 50 microns.

Example 6. The method of Example 4, wherein:
the grain size is less than approximately 20 microns.

Example 7. The method of Example 1, further comprising:
purifying the hydrogen gas product, wherein:
the purifying occurs after the collecting.

Example 8. The method of Example 7, wherein:
the purifying comprises cooling the hydrogen gas product, and
the cooling results in a water being condensed out of the hydrogen gas product.

Example 9. The method of Example 7, wherein:
the purifying comprises separating the hydrogen gas product, and
the separating comprises removing another gas from the hydrogen gas product.

Example 10. The method of Example 9, wherein:
the another gas comprises at least one of methane, carbon dioxide, nitrogen, or oxygen.

Example 11. The method of Example 1, further comprising:
disposing of the slurry waste; wherein:
the disposing occurs after the collecting.

Example 12. The method of Example 1, wherein:
the mixing comprises:
   stirring the mixture; and
   heating the mixture.

Example 13. The method of Example 12, wherein:
the heating results in the mixture being at a temperature less than 150° C.

Example 14. The method of Example 1, wherein:
the mixing is performed for a time in the range of approximately 24 hours to 6 months.

Example 15. The method of Example 1, wherein:
the reactor comprises:
an interior space;
a heating mechanism;
a stirring mechanism located in the interior space;
an inlet;
a first outlet; and
a second outlet.

Example 16. The method of Example 15, wherein:
the heating mechanism comprises an electric heater or a hydrogen burner.

Example 17. The method of Example 16, wherein:
the hydrogen burner utilizes the hydrogen gas product.

Example 18. The method of Example 15, wherein:
the heating mechanism is capable of heating the interior space to approximately 500° C.

Example 19. The method of Example 15, wherein:
the stirring mechanism comprises an agitator, and
the agitator is configured to move to mix the IOT and the liquid.

Example 20. The method of Example 15, wherein:
the collecting comprises:
removing the slurry waste from the reactor via the first outlet, and
removing the hydrogen gas product from the reactor via the second outlet.

Example 21. A device for generating a hydrogen gas product from an iron ore tailing (IOT), the device comprising:
an interior space;
a heating mechanism;
a stirring mechanism located in the interior space;
an inlet configured to receive the IOT;
a first outlet; and
a second outlet; wherein:
the stirring mechanism is configured to mix the IOT in the interior space, resulting in a hydrogen gas product and a slurry waste.

Example 22. The device of Example 21, wherein:
the heating mechanism comprises an electric heater or a hydrogen burner.

Example 23. The device of Example 22, wherein:
the hydrogen burner utilizes the hydrogen gas product.

Example 24. The device of Example 21, wherein:
the heating mechanism is configured to heat the IOT to 150° C.

Example 25. The device of Example 21, wherein:
the stirring mechanism comprises an agitator, and
the agitator is configured to move the IOT.

Example 26. The device of Example 21, wherein:
the inlet is located substantially near the top of the device.

Example 27. The device of Example 21, wherein:
the first outlet is located substantially near the bottom of the device,
the first outlet is configured to release the slurry waste,
the second outlet is located substantially near the top of the device, and
the second outlet is configured to release the hydrogen gas product.

Example 28. The device of Example 21, wherein:
the IOT comprises at least 1 wt % water.

Example 29. The device of Example 21, wherein:
the inlet is configured to receive a water; and
the stirring mechanism is configured to mix the water and the IOT.

Example 30. The device of Example 21, further comprising:
a gas separator configured to purify the hydrogen gas product.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A method of generating a hydrogen gas product from an iron ore tailing (IOT), the method comprising:
feeding the IOT into a reactor;
mixing the IOT in a reactor resulting in the hydrogen gas product and a slurry waste; and
collecting the hydrogen gas product from the reactor.

2. The method of claim 1, further comprising:
combining the IOT with a liquid; wherein:
the combining is performed prior to the mixing, and
the liquid comprises water.

3. The method of claim 1, wherein:
the IOT comprises at least 1 wt % water.

4. The method of claim 1, further comprising:
grinding the IOT; wherein:
the grinding is performed before the feeding, and
the grinding results in the IOT having a grain size.

5. The method of claim 4, wherein:
the grain size is less than approximately 50 microns.

6. The method of claim 4, wherein:
the grain size is less than approximately 20 microns.

7. The method of claim 1, further comprising:
purifying the hydrogen gas product, wherein:
the purifying occurs after the collecting.

8. The method of claim 7, wherein:
the purifying comprises cooling the hydrogen gas product, and
the cooling results in a water being condensed out of the hydrogen gas product.

9. The method of claim 7, wherein:
the purifying comprises separating the hydrogen gas product, and
the separating comprises removing another gas from the hydrogen gas product.

10. The method of claim 9, wherein:
the another gas comprises at least one of methane, carbon dioxide, nitrogen, or oxygen.

11. The method of claim 1, further comprising:
disposing of the slurry waste; wherein:
the disposing occurs after the collecting.

12. The method of claim 1, wherein:
the mixing comprises:
stirring the IOT; and
heating the IOT.

13. The method of claim 12, wherein:
the heating results in the mixture being at a temperature less than 150° C.

14. The method of claim 1, wherein:
the mixing is performed for a time in the range of approximately 24 hours to 6 months.

15. The method of claim 1, wherein:
the reactor comprises:
an interior space;
a heating mechanism;
a stirring mechanism located in the interior space;
an inlet;
a first outlet; and
a second outlet.

16. The method of claim 15, wherein:
the heating mechanism comprises an electric heater or a hydrogen burner.

17. The method of claim 16, wherein:
the hydrogen burner utilizes the hydrogen gas product.

18. The method of claim 15, wherein:
the heating mechanism is capable of heating the interior space to approximately 500° C.

19. The method of claim 15, wherein:
the stirring mechanism comprises an agitator, and
the agitator is configured to move to mix the IOT and the liquid.

20. The method of claim 15, wherein:
the collecting comprises:
removing the slurry waste from the reactor via the first outlet, and
removing the hydrogen gas product from the reactor via the second outlet.
